(19) United States
(12) Patent Application Publication
(10) Pub. No.: US 2011/0290573 A1
(43) Pub. Date: Dec. 1, 2011

(54) VEHICLE, METHOD AND APPARATUS FOR CONTROLLING VEHICLE

(75) Inventor: Hideto HANADA, Toyota-shi (JP)

(73) Assignee: TOYOTA JIDOSHA KABUSHIKI KAISHA, Toyota-shi (JP)

(21) Appl. No.: 13/113,666

(22) Filed: May 23, 2011

(30) Foreign Application Priority Data
Jun. 1, 2010 (JP) 2010-125722

(51) Int. Cl. B60W 20/00; H02P 21/00

(52) U.S. Cl. 180/65.285; 318/400.02

(57) ABSTRACT

A vehicle incorporates a first motor generator and a second motor generator. A first inverter supplies a current to the first motor generator. The vehicle is controlled to travel using only the second motor generator as a driving source. In a state where the vehicle is traveling using only the second motor generator as a driving source, the first inverter supplies a current to the first motor generator such that a q-axis current becomes zero and a d-axis current flows in the first motor generator.

This nonprovisional application is based on Japanese Patent Application No. 2010-125722 filed on Jun. 1, 2010 with the Japan Patent Office, the entire contents of which are hereby incorporated by reference.

### BACKGROUND OF THE INVENTION

1. Field of the Invention

The present invention relates to a vehicle, a method and an apparatus for controlling the vehicle, and more particularly to a technique for controlling a vehicle incorporating a first rotating electric machine, and a second rotating electric machine as a driving source, such that the first rotating electric machine emits a sound.

2. Description of the Background Art

Hybrid cars incorporating rotating electric machines as their driving sources are known. A hybrid car can travel using at least one of an engine and a rotating electric machine as a driving source. A hybrid car can also travel using only a rotating electric machine as a driving source.

During travel using only the rotating electric machine as a driving source, however, the vehicle emits a very small sound since the engine has been deactivated. It is thus difficult for pedestrians and the like to be aware of the approaching vehicle. For this reason, as described in Japanese Patent Laying-Open No. 2005-278281, a technique has been proposed for increasing the level of a sound of an electrical drive system which generates a driving force with a rotating electric machine when an object is sensed around a vehicle. Japanese Patent Laying-Open No. 2005-278281 discloses in paragraphs 81 and the like that the level of noise is increased by driving the rotating electric machine used mainly as a power generator, for example.

When the rotating electric machine is driven, however, power consumption for increasing the level of a sound may be increased.

### SUMMARY OF THE INVENTION

An object of the present invention is to reduce power consumption for generating a sound.

A vehicle in one embodiment includes a first rotating electric machine, a second rotating electric machine, and a control unit that supplies a current to the first rotating electric machine such that a q-axis current becomes zero and a d-axis current flows in the first rotating electric machine in a state where the vehicle is traveling using the second rotating electric machine as a driving source.

According to this structure, the current is supplied to the first rotating electric machine such that the d-axis current of the first rotating electric machine flows. Thus, a ripple current can be applied to the first rotating electric machine to emit a sound. On the other hand, the q-axis current becomes zero. Thus, the vehicle can be controlled such that the first rotating electric machine is not driven. As a result, power consumption for generating a sound can be reduced in the state where the vehicle is traveling using the second rotating electric machine as a driving source.

A vehicle in another embodiment includes a power storage device that stores electric power, a voltage converter connected to the power storage device that converts a voltage, a first rotating electric machine, a second rotating electric machine, and a control unit that supplies electric power output from the voltage converter to the first rotating electric machine such that a q-axis current and a d-axis current of the first rotating electric machine become zero in a state where the vehicle is traveling using the second rotating electric machine as a driving source, and controls the voltage converter such that a voltage supplied to the first rotating electric machine is varied in the state where the vehicle is traveling using the second rotating electric machine as a driving source.

According to this structure, the current is supplied to the first rotating electric machine such that the q-axis current and the d-axis current of the first rotating electric machine become zero. Thus, a ripple current is applied to the first rotating electric machine to emit a sound. In addition, the ripple current applied to the first rotating electric machine is increased or decreased by increasing or decreasing the voltage supplied to the first rotating electric machine. Thus, the level of a sound emitted by the first rotating electric machine can be increased or decreased. Since the q-axis current and the d-axis current are zero, the first rotating electric machine is not driven. As a result, power consumption for generating a sound can be reduced in the state where the vehicle is traveling using the second rotating electric machine as a driving source.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a hybrid vehicle.

FIG. 2 is a cross-sectional view of a first motor generator.

FIG. 3 shows a PWM signal.

FIG. 4 shows a nomographic chart of a power split device (No. 1).

FIG. 5 shows a nomographic chart of the power split device (No. 2).

FIG. 6 shows a nomographic chart of the power split device (No. 3).

FIG. 7 shows an electrical system of the hybrid vehicle.

FIG. 8 is a flowchart showing a process executed by the electrical system in a first embodiment.

FIG. 9 shows a ripple current.

FIG. 10 shows a vector diagram of a d-axis and a q-axis (No. 1).

FIG. 11 shows a vector diagram of the d-axis and the q-axis (No. 2).

FIG. 12 is a flowchart showing a process executed by the electrical system in a second embodiment.

FIG. 13 is a flowchart showing a process executed by the electrical system in a third embodiment.

### DESCRIPTION OF THE PREFERRED EMBODIMENTS

An embodiment of the present invention will be described hereinafter with reference to the drawings. In the following description, the same components are designated with the same characters. Their names and functions are also the same. Thus, detailed descriptions thereof will not be repeated.

### First Embodiment

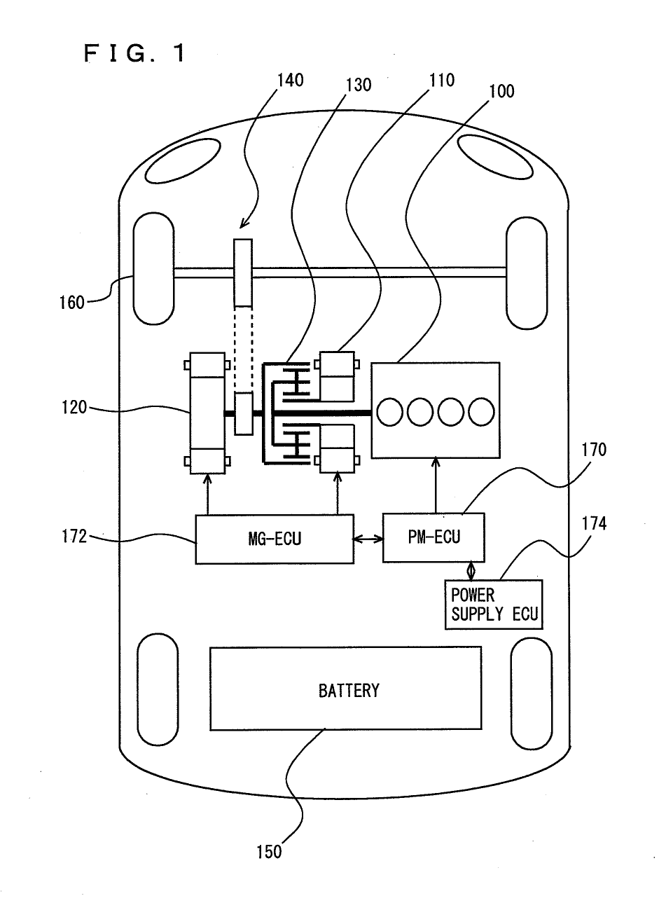

Referring to FIG. 1, a hybrid vehicle incorporating a control apparatus according to a first embodiment is described. This vehicle includes an engine 100, a first motor generator 110, a second motor generator 120, a power split device 130, a speed reducer 140, and a battery 150.

This vehicle travels using a driving force from at least one of engine 100 and second motor generator 120. Engine 100, first motor generator 110 and second motor generator 120 are coupled to one another via power split device 130. Motive power generated by engine 100 is split for two paths by power split device 130. One of them is a path for driving front wheels 160 via speed reducer 140. The other is a path for driving first motor generator 110 to generate power.

First motor generator 110 is a three-phase AC rotating electric machine including a U-phase coil, a V-phase coil and a W-phase coil. First motor generator 110 generates power using a driving force generated by engine 100 and split by power split device 130. The electric power generated by first motor generator 110 is used depending on a traveling state of the vehicle, and an SOC (State Of Charge) of battery 150. For example, during normal travel, the electric power generated by first motor generator 110 is used directly as electric power for driving second motor generator 120. On the other hand, when the SOC of battery 150 is lower than a predetermined value, the electric power generated by first motor generator 110 is converted from AC power to DC power by an inverter to be described later. Then, the electric power is adjusted in voltage by a converter to be described later, and stored in battery 150.

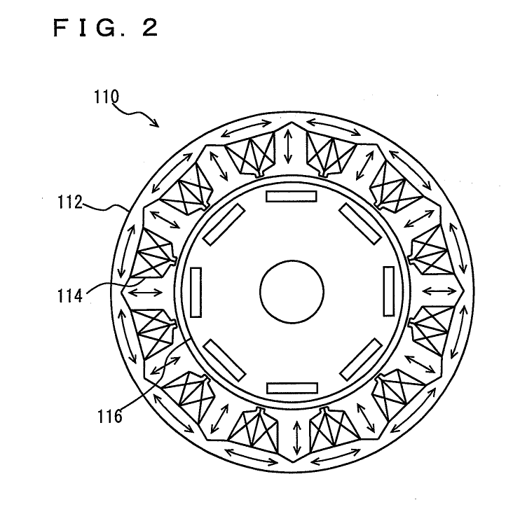

FIG. 2 is a cross-sectional view of first motor generator 110. First motor generator 110 includes a cylindrical case (not shown), a stator 112 accommodated on the inner side in a radial direction of the case, a coil 114 wound around stator 112, and a rotor 116 provided to rotate on the inner side in a radial direction of stator 112.

When a current is fed through coil 114, magnetic flux passes through stator 112. The magnetic flux passing through stator 112 flow radially in a teeth portion, and in a circumferential direction in a yoke portion, as shown with arrows in FIG. 2.

When the current flowing through coil 114 is varied, a magnetic field generated in first motor generator 110 is varied. The variation in magnetic field involves oscillation of first motor generator 110. The oscillation causes first motor generator 110 to generate noise.

Referring back to FIG. 1, second motor generator 120 is a three-phase AC rotating electric machine including a U-phase coil, a V-phase coil and a W-phase coil. Second motor generator 120 is driven by at least one of the electric power stored in battery 150 and the electric power generated by first motor generator 110.

A driving force from second motor generator 120 is transmitted to front wheels 160 via speed reducer 140. In this manner, second motor generator 120 assists engine 100, and the vehicle travels using the driving force from second motor generator 120. Instead of or in addition to front wheels 160, rear wheels may be driven.

During regenerative braking of the hybrid vehicle, front wheels 160 drive second motor generator 120 via speed reducer 140, and second motor generator 120 operates as a power generator. As a result, second motor generator 120 operates as a regenerative brake for converting braking energy to electric power. The electric power generated by second motor generator 120 is stored in battery 150.

Second motor generator 120 has a structure similar to that of first motor generator 110. Thus, detailed description thereof will not be repeated.

First motor generator 110 and second motor generator 120 are subjected to PWM (Pulse Width Modulation) control, for example.

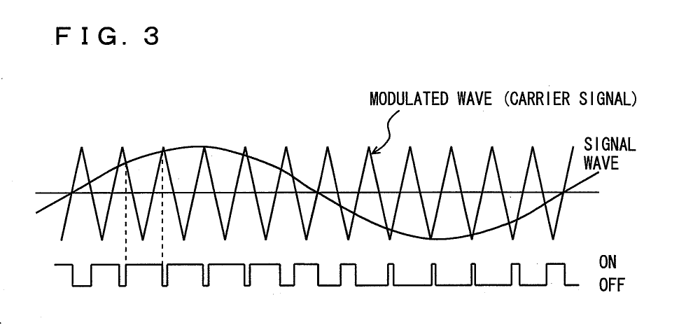

As is well known, a PWM signal is produced based on a modulated wave (carrier signal) and a signal wave, as shown in FIG. 3. A well-known common technique may be employed for subjecting first motor generator 110 and second motor generator 120 to PWM control, and thus further detailed description thereof will not be repeated.

Referring back to FIG. 1, power split device 130 is a planetary gear unit including a sun gear, a pinion gear, a carrier, and a ring gear. The pinion gear engages with the sun gear and the ring gear. The carrier supports the pinion gear in such a manner that allows rotation of the pinion gear. The sun gear is coupled to a shaft of first motor generator 110. The carrier is coupled to a crankshaft of engine 100. The ring gear is coupled to a shaft of second motor generator 120 and speed reducer 140.

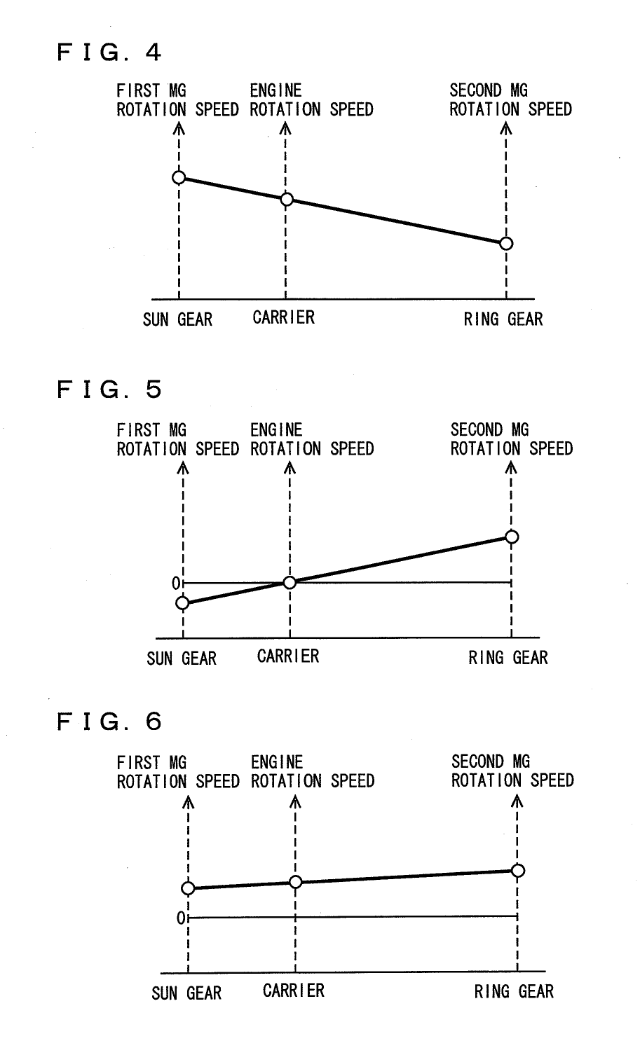

Since engine 100, first motor generator 110 and second motor generator 120 are coupled to one another via the planetary gear unit, rotation speeds of engine 100, first motor generator 110 and second motor generator 120 are in such a relation that they are connected by a straight line in a nomographic chart as shown in FIG. 4.

Accordingly, when engine 100 is deactivated and the hybrid vehicle travels using only the driving force from second motor generator 120, as shown in FIG. 5, the output shaft rotation speed of second motor generator 120 becomes positive, and the output shaft rotation speed of first motor generator 110 becomes negative.

When engine 100 is started, as shown in FIG. 6, the output shaft rotation speed of first motor generator 110 becomes positive by operating first motor generator 110 as a motor to crank engine 100 using first motor generator 110.

Referring back to FIG. 1, battery 150 is a battery pack formed by integrating a plurality of battery cells into a battery module, and further connecting a plurality of the battery modules in series. Battery 150 has a voltage of approximately 200 V, for example. Battery 150 is charged with the electric power generated by first motor generator 110 or second motor generator 120. A temperature of battery 150 is detected by a temperature sensor.

Engine 100 is controlled by a PM (Power train Manager)-ECU (Electronic Control Unit) 170. First motor generator 110 and second motor generator 120 are controlled by an MG (Motor-Generator)-ECU 172. PM-ECU 170 and MG-ECU 172 are connected such that they can conduct bidirectional communication with each other.

In addition to the function of controlling engine 100, PM-ECU 170 has the function of managing MG-ECU 172. For example, activation (turn-on) and deactivation (turn-off) of MG-ECU 172 is controlled by a command signal from PM-ECU 170. In addition, PM-ECU 170 provides MG-ECU 172 with commands for a torque of first motor generator 110 and a torque of second motor generator 120, and the like.

PM-ECU 170 can be deactivated by a command from PM-ECU 170 itself. Activation of PM-ECU 170 is managed by a power supply ECU 174.

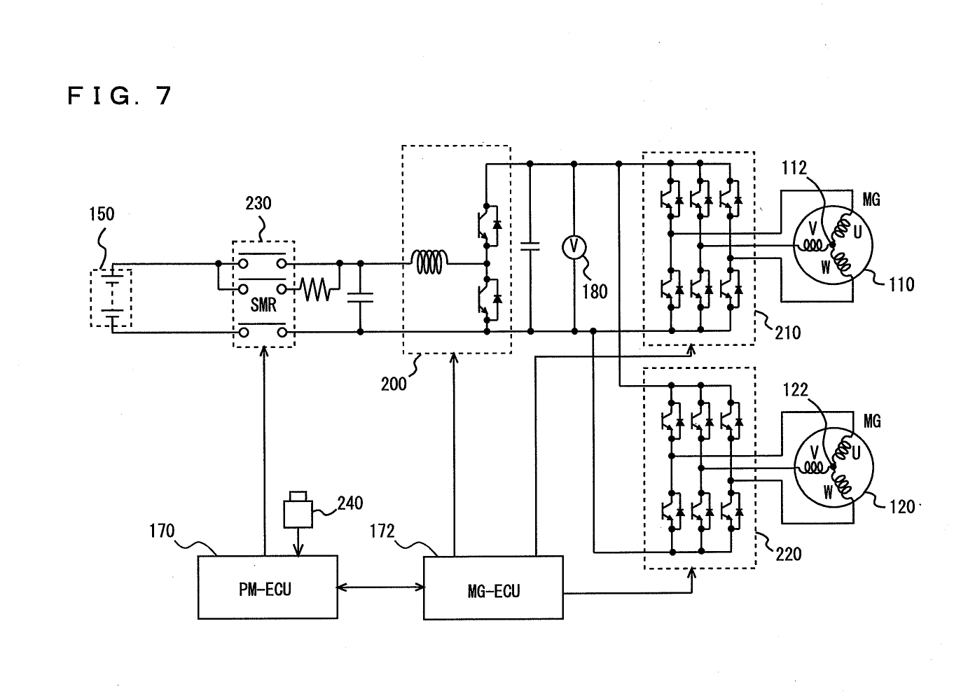

Referring to FIG. 7, an electrical system of the hybrid vehicle is further described. The hybrid vehicles includes a converter 200, a first inverter 210, a second inverter 220, and an SMR (System Main Relay) 230.

Converter 200 includes a reactor, two npn-type transistors, and two diodes. The reactor has one end connected to a positive electrode side of battery 150, and the other end connected to a connection point of the two npn-type transistors.

The two npn-type transistors are connected in series. The npn-type transistors are controlled by MG-ECU 172. Between a collector and an emitter of each npn-type transistor, a diode is connected to allow a current flow from the emitter side to the collector side.

As the npn-type transistor, an IGBT (Insulated Gate Bipolar Transistor) can be used, for example. Instead of the npn-type transistor, a power switching element such as a power MOSFET (Metal Oxide Semiconductor Field-Effect Transistor) can be used.

When electric power discharged from battery 150 is supplied to first motor generator 110 or second motor generator 120, converter 200 boosts a voltage of the power. Conversely, when battery 150 is charged with electric power generated by first motor generator 110 or second motor generator 120, converter 200 steps down a voltage of the power.

A system voltage VH among converter 200, first inverter 210 and second inverter 220 is detected by a voltage sensor 180. A result of detection by voltage sensor 180 is sent to MG-ECU 172.

When converter 200 varies the voltage, a voltage supplied from first inverter 210 to first motor generator 110 and a voltage supplied from second inverter 220 to second motor generator 120 are varied.

First inverter 210 includes a U-phase arm, a V-phase arm and a W-phase arm. The U-phase arm, the V-phase arm and the W-phase arm are connected in parallel. Each of the U-phase arm, the V-phase arm and the W-phase arm has two npn-type transistors connected in series. Between a collector and an emitter of each npn-type transistor, a diode is connected to allow a current flow from the emitter side to the collector side. A connection point of the npn-type transistors in each arm is connected to an end different from a neutral point of each coil in first motor generator 110.

First inverter 210 converts a direct current supplied from battery 150 to an alternating current, and supplies it to first motor generator 110. Namely, first inverter 210 supplies electric power output from converter 200 to first motor generator 110. First inverter 210 also converts an alternating current generated by first motor generator 110 to a direct current.

Further, in the present embodiment, in a state where the vehicle is traveling using only second motor generator 120 as a driving source, first inverter 210 supplies a current to first motor generator 110 such that first motor generator 110 emits a sound. For example, when a driver operates and turns on a traveling sound switch 240, first motor generator 110 is controlled to emit a sound in the state where the vehicle is traveling using only second motor generator 120 as a driving source. Second inverter 220 includes a U-phase arm, a V-phase arm and a W-phase arm.

The U-phase arm, the V-phase arm and the W-phase arm are connected in parallel. Each of the U-phase arm, the V-phase arm and the W-phase arm has two npn-type transistors connected in series. Between a collector and an emitter of each npn-type transistor, a diode is connected to allow a current flow from the emitter side to the collector side. A connection point of the npn-type transistors in each arm is connected to an end different from a neutral point of each coil in second motor generator 120.

Second inverter 220 converts a direct current supplied from battery 150 to an alternating current, and supplies it to second motor generator 120. Namely, second inverter 220 supplies electric power output from converter 200 to second motor generator 120. Second inverter 220 also converts an alternating current generated by second motor generator 120 to a direct current.

Converter 200, first inverter 210 and second inverter 220 are controlled by MG-ECU 172. MG-ECU 172 controls first inverter 210 to output a torque in accordance with a torque command value input from PM-ECU 170. Likewise, MG-ECU 172 controls second inverter 220 to output a torque in accordance with a torque command value input from PM-ECU 170.

For example, a d-axis current command value idc and a q-axis current command value iqc are set in accordance with the torque command value, based on a map prepared in advance by developers and the like.

In addition, through conversion from three phases to two phases using an angle of rotation θ of the motor generator, a d-axis current id and a q-axis current iq are calculated from currents of the U-phase, the V-phase and the W-phase.

With PI control based on a difference Δid (Δid=idc−id) relative to the d-axis current command value and a difference Δiq (Δiq=iqc−iq) relative to the q-axis current command value and the like, a d-axis voltage command value Vdc and a q-axis voltage command value Vqc are set.

Further, through conversion from two phases to three phases, d-axis voltage command value Vdc and q-axis voltage command value Vqc are converted to voltage commands Vu, Vv and Vw of the U-phase, the V-phase and the W-phase, respectively. First inverter 210 and second inverter 220 are controlled to realize voltage commands Vu, Vv and Vw.

A well-known common method may be employed for controlling the inverters such that the motor generators output torque in accordance with the torque command value, and thus further detailed description thereof will not be repeated.

SMR 230 is provided between battery 150 and converter 200. SMR 230 is a relay for switching between a state where battery 150 and the electrical system are connected to each other and a state where they are disconnected from each other. When SMR 230 is in the opened state, battery 150 is disconnected from the electrical system. When SMR 230 is in the closed state, battery 150 is connected to the electrical system.

Namely, when SMR 230 is in the opened state, battery 150 is electrically disconnected from converter 200 and the like. When SMR 230 is in the closed state, battery 150 is electrically connected to converter 200 and the like.

The state of SMR 230 is controlled by PM-ECU 170. For example, when PM-ECU 170 is activated, SMR 230 is closed. When PM-ECU 170 is deactivated, SMR 230 is opened.

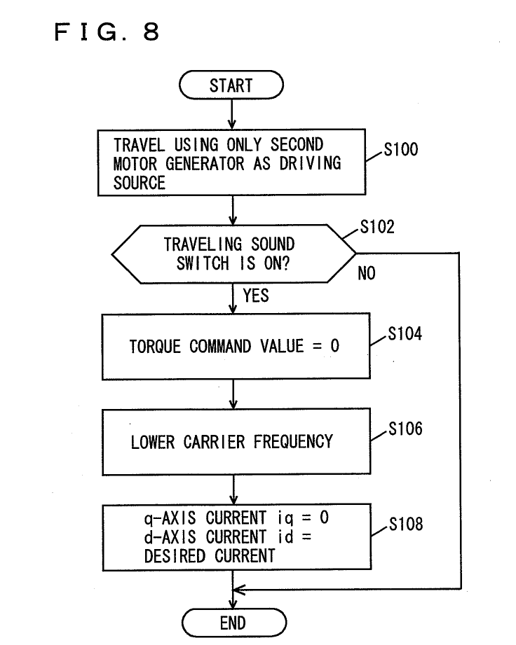

Referring to FIG. 8, a process executed by the electrical system in the present embodiment is described.

At step (step is abbreviated as “S” hereinafter) 100, the vehicle is controlled to travel using only second motor generator 120 as a driving source. For example, when the driver operates an EV switch, the vehicle is controlled to travel using only second motor generator 120 as a driving source. Alternatively, the vehicle may be controlled to travel using only second motor generator 120 as a driving source when an accelerator pedal position is smaller than a threshold value, namely, when traveling power demanded by the driver is smaller than the threshold value.

At S102, it is determined whether or not traveling sound switch 240 is ON. If traveling sound switch 240 is ON (YES at step S102), the process proceeds to S104. If traveling sound switch 240 is OFF (NO at step S102), the process ends.

Instead of determining whether or not traveling sound switch 240 is ON, whether or not vehicle speed is equal to or lower than the threshold value may be determined. In this case, if the vehicle speed is equal to or lower than the threshold value, the process may proceed to S104, and if the vehicle speed is higher the threshold value, the process may end.

At S104, a torque command value for first motor generator 110 is set to zero. At S106, a frequency of a carrier signal in the PWM control for first motor generator 110 is lowered. For example, the frequency of the carrier signal is lowered to a frequency within the audible area of human hearing.

At S108, first inverter 210 supplies a current to first motor generator 110 such that q-axis current Iq becomes zero and d-axis current id flows in first motor generator 110. Namely, first inverter 210 is controlled such that q-axis current Iq becomes zero and d-axis current id coincides with a desired current in first motor generator 110.

D-axis current id is increased to a degree that allows a pedestrian to hear a sound emitted by first motor generator 110, for example. D-axis current id may be controlled to increase a sound emitted by first motor generator 110 in a phased manner. D-axis current id may be increased or decreased to increase or decrease a sound emitted by first motor generator 110.

The action based on the structure and the flowchart as described above is described.

In the state where the vehicle is traveling using only second motor generator 120 as a driving source, when traveling sound switch 240 is ON, a torque command value for first motor generator 110 is set to zero. In addition, a frequency of a carrier signal in the PWM control is lowered.

Further, first inverter 210 supplies a current to first motor generator 110 to flow d-axis current id of first motor generator 110. Thus, first inverter 210 operates to supply a current to each coil of the U-phase, the V-phase and the W-phase of first motor generator 110.

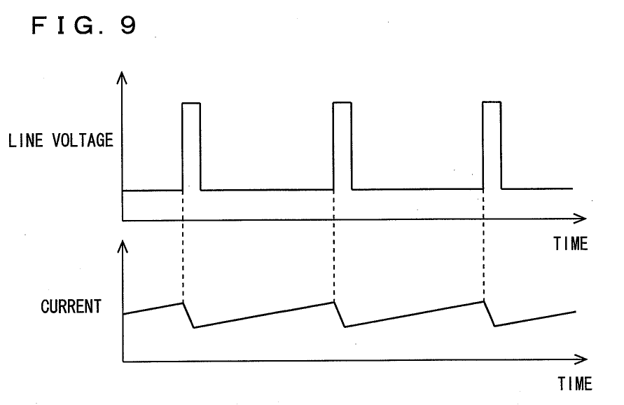

As shown in FIG. 9, a ripple current depending on a line voltage is applied to first motor generator 110. The ripple current causes the stator in first motor generator 110 to generate an electromagnetic force. The electromagnetic force involves oscillation of rotor 116 and stator 112. The oscillation of rotor 116 and stator 112 is transmitted to the case of first motor generator 110. As a result, a sound is generated.

Meanwhile, the q-axis current is set to zero. Thus, first motor generator 110 is not driven. Accordingly, in the state where the vehicle is traveling using only second motor generator 120 as a driving source, power consumption for generating a sound can be reduced.

As described above, the sound generated by first motor generator 110 depends on the ripple current. The ripple current depends on the line voltage of first inverter 210. Here, it is known that a d-axis voltage Vd and a q-axis voltage Vq are expressed in the following equations.

Vd=−ω·Lq·iq (1)

Vq=−ω·Ld·id+ωΨ (2)

In the equations 1 and 2, ω represents an electrical angular velocity. Ld represents a d-axis inductance. Lq represents a q-axis inductance. Ψ indicates an armature interlinkage magnetic flux of a permanent magnet.

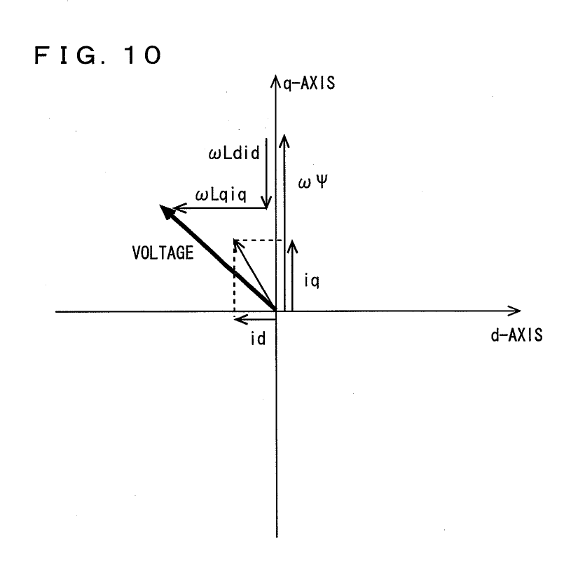

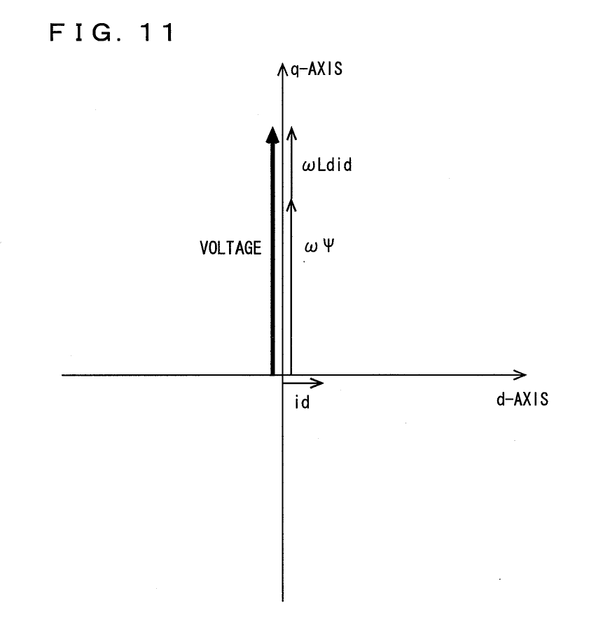

A voltage applied to first motor generator 110 based on the equations 1 and 2 is shown in a vector diagram of FIG. 10. In the present embodiment, since q-axis current iq is set to zero, the voltage applied to first motor generator 110 can be increased in accordance with d-axis current id, as shown in FIG. 11. The voltage applied to first motor generator 110 can also be decreased in accordance with d-axis current id. Accordingly, a sound emitted by first motor generator 110 can be adjusted using d-axis current id.

### Second Embodiment

A second embodiment is described below. In the present embodiment, in the state where the vehicle is traveling using only second motor generator 120 as a driving source, converter 200 is controlled such that the voltage supplied to first motor generator 110 is varied.

The other features are the same as those in the first embodiment discussed above, and thus detailed description thereof will not be repeated.

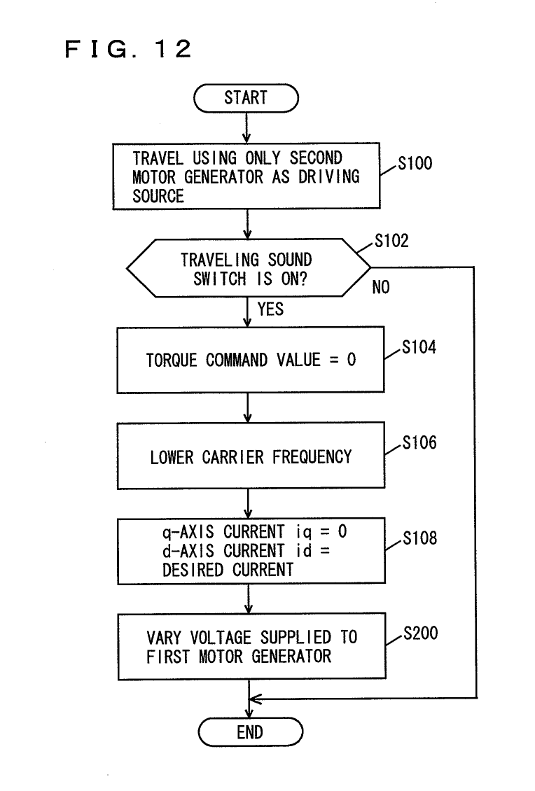

Referring to FIG. 12, a process executed by the electrical system in the present embodiment is described. The steps the same as those in the first embodiment discussed above are denoted with the same reference signs. Thus, detailed description thereof will not be repeated.

At S200, converter 200 is controlled such that the voltage supplied to first motor generator 110 is varied. For example, the voltage supplied to first motor generator 110 is increased to a degree that allows a pedestrian to hear a sound emitted by first motor generator 110. Converter 200 may be controlled such that the voltage supplied to first motor generator 110 fluctuates.

As a result, the line voltage of first inverter 210 can be directly controlled. Accordingly, the level of a sound emitted by first motor generator 110 can be controlled.

### Third Embodiment

A third embodiment is described below. The present embodiment is different from the second embodiment discussed above in that, in the state where the vehicle is traveling using only second motor generator 120 as a driving source, q-axis current iq as well as d-axis current id are set to zero. The other features are the same as those in the second embodiment discussed above. Thus, detailed description thereof will not be repeated.

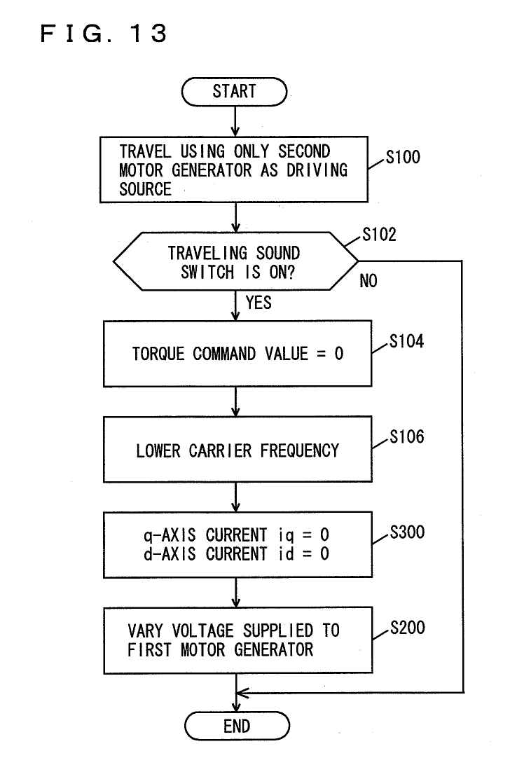

Referring to FIG. 13, a process executed by the electrical system in the present embodiment is described. The steps the same as those in the first embodiment discussed above are denoted with the same reference signs. Thus, detailed description thereof will not be repeated.

At S300, first inverter 210 supplies a current to first motor generator 110 such that d-axis current id and q-axis current iq of first motor generator 110 become zero. Namely, first inverter 210 is controlled such that d-axis current id and q-axis current iq of first motor generator 110 become zero.

As a result, the line voltage of first inverter 210 can again be directly controlled. Accordingly, the level of a sound emitted by first motor generator 110 can be controlled.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A vehicle comprising:
a first rotating electric machine;
a second rotating electric machine; and
a control unit that supplies a current to said first rotating electric machine such that a q-axis current becomes zero and a d-axis current flows in said first rotating electric machine in a state where said vehicle is traveling using said second rotating electric machine as a driving source.

2. The vehicle according to claim 1, further comprising a switch operated by a driver, wherein
when said switch is operated by the driver, said control unit supplies a current to said first rotating electric machine such that the q-axis current becomes zero and the d-axis current flows in said first rotating electric machine in the state where said vehicle is traveling using said second rotating electric machine as a driving source.

3. The vehicle according to claim 1, further comprising:
a power storage device that stores electric power; and
a voltage converter connected to said power storage device that converts a voltage, wherein
said control unit
supplies electric power output from said voltage converter to said first rotating electric machine such that the q-axis current becomes zero and the d-axis current flows in said first rotating electric machine in the state where said vehicle is traveling using said second rotating electric machine as a driving source, and
controls said voltage converter such that a voltage supplied to said first rotating electric machine is varied in the state where said vehicle is traveling using said second rotating electric machine as a driving source.

4. The vehicle according to claim 1, further comprising:
an internal combustion engine; and
a differential mechanism including a first rotating element coupled to said first rotating electric machine, a second rotating element coupled to said internal combustion engine, and a third rotating element coupled to said second rotating electric machine.

5. The vehicle according to claim 1, wherein
each of said first rotating electric machine and said second rotating electric machine is a three-phase AC rotating electric machine.

6. A vehicle comprising:
a power storage device that stores electric power;
a voltage converter connected to said power storage device that converts a voltage;
a first rotating electric machine;
a second rotating electric machine; and
a control unit that supplies electric power output from said voltage converter to said first rotating electric machine such that a q-axis current and a d-axis current of said first rotating electric machine become zero in a state where said vehicle is traveling using said second rotating electric machine as a driving source, and controls said voltage converter such that a voltage supplied to said first rotating electric machine is varied in the state where said vehicle is traveling using said second rotating electric machine as a driving source.

7. The vehicle according to claim 6, further comprising a switch operated by a driver, wherein
said control unit
supplies, when said switch is operated by the driver, electric power output from said voltage converter to said first rotating electric machine such that the q-axis current and the d-axis current of said first rotating electric machine become zero in the state where said vehicle is traveling using said second rotating electric machine as a driving source, and
controls, when said switch is operated by the driver, said voltage converter such that a voltage supplied to said first rotating electric machine is varied in the state where said vehicle is traveling using said second rotating electric machine as a driving source.

8. The vehicle according to claim 6, further comprising:
an internal combustion engine; and
a differential mechanism including a first rotating element coupled to said first rotating electric machine, a second rotating element coupled to said internal combustion engine, and a third rotating element coupled to said second rotating electric machine.

9. The vehicle according to claim 6, wherein
each of said first rotating electric machine and said second rotating electric machine is a three-phase AC rotating electric machine.

10. A method for controlling a vehicle incorporating a first rotating electric machine and a second rotating electric machine, comprising the steps of:
controlling said vehicle to travel using said second rotating electric machine as a driving source; and
supplying a current to said first rotating electric machine such that a q-axis current becomes zero and a d-axis current flows in said first rotating electric machine in a state where said vehicle is traveling using said second rotating electric machine as a driving source.

11. A method for controlling a vehicle incorporating a power storage device for storing electric power, a voltage converter connected to said power storage device for converting a voltage, a first rotating electric machine, and a second rotating electric machine, comprising the steps of:
controlling said vehicle to travel using said second rotating electric machine as a driving source;
supplying electric power output from said voltage converter to said first rotating electric machine such that a q-axis current and a d-axis current of said first rotating electric machine become zero in a state where said vehicle is traveling using said second rotating electric machine as a driving source, and
controlling said voltage converter such that a voltage supplied to said first rotating electric machine is varied in the state where said vehicle is traveling using said second rotating electric machine as a driving source.

12. An apparatus for controlling a vehicle incorporating a first rotating electric machine and a second rotating electric machine, comprising:
means for controlling said vehicle to travel using said second rotating electric machine as a driving source; and
supply means for supplying a current to said first rotating electric machine such that a q-axis current becomes zero and a d-axis current flows in said first rotating electric machine in a state where said vehicle is traveling using said second rotating electric machine as a driving source.

13. An apparatus for controlling a vehicle incorporating a power storage device for storing electric power, a voltage converter connected to said power storage device for converting a voltage, a first rotating electric machine, and a second rotating electric machine, comprising:
means for controlling said vehicle to travel using said second rotating electric machine as a driving source;
supply means for supplying electric power output from said voltage converter to said first rotating electric machine such that a q-axis current and a d-axis current of said first rotating electric machine become zero in a state where said vehicle is traveling using said second rotating electric machine as a driving source; and
control means for controlling said voltage converter such that a voltage supplied to said first rotating electric machine is varied in the state where said vehicle is traveling using said second rotating electric machine as a driving source.
